(19) United States
(12) Patent Application Publication
(10) Pub. No.: US 2013/0332242 A1
(43) Pub. Date: Dec. 12, 2013

(54) SYSTEM AND METHOD FOR FACILITATING THE ADVANCEMENT OF A RESEARCH ARTICLE FROM CONCEPTION TO POST-PUBLICATION

(71) Applicant: Copyright Clearance Center, Inc., Danvers, MA (US)

(72) Inventors: Ramy Arnaout, Chestnut Hill, MA (US); Roy Kaufman, New York, NY (US); Jennifer Goodrich, Warner, NH (US); Ken Okaya, Newburyport, MA (US)

(21) Appl. No.: 13/915,112

(22) Filed: Jun. 11, 2013

Related U.S. Application Data
(60) Provisional application No. 61/658,198, filed on Jun. 11, 2012.

(51) Int. Cl. G06Q 10/06

(52) U.S. Cl. CPC G06Q 10/0637
USPC 705/7.36

(57) ABSTRACT

A comprehensive, web-based, authorship workflow management system serves as a central hub that electronically links authors of research articles with a plurality of conventional authorship partnering entities, such as funding agencies, publishers, licensing partners, text editors, peer reviewers and the like. In use, the workflow management system facilitates the advancement of a research article from conception to post-publication by, among other things, streamlining the process in which an author obtains a financial grant for a designated project, providing enhanced tools for conducting research and drafting a corresponding research article, submitting publication requests to a plurality of publishers in a prioritized, cascading fashion, and efficiently processing any fees to be collected on behalf of designated entities. Throughout the authorship experience, the workflow management system provides author-defined updates regarding the status of the article through the transmission of electronic notifications to the author and selected partnering entities.

### FIELD OF THE INVENTION

The present invention relates generally to research conducted in the fields of science, technology and medicine and more particularly to methods for funding, publishing and licensing journal articles derived from such research.

### BACKGROUND OF THE INVENTION

A research article is a written paper that explores the impact of information obtained through conducting extensive scientific research. To promote greater exposure in scientific, technological and medical (STM) communities, research articles are often published in well-respected, industry-specific journals.

The process in which a research article is authored and published typically includes a defined sequence of stages, or phases, that together are referred to herein simply as the authorship workflow. As can be appreciated, the authorship workflow typically relies upon a substantial network of independent participants including, but not limited to, the article author, funding agencies, publishers, licensing partners, text editors and peer reviewers. As will become apparent below, the involvement of such a substantial network results in, among other things, a workflow that is largely inefficient in nature due to the lack of effective tools for sharing information between participants.

The primary stage in the authorship workflow is commonly referred to as the submission stage. In the submission stage, the author conceives of the idea that is to become the foundation for the research article. With the idea conceived, the author typically seeks to obtain a financial grant from a known funding institution, or agency, by submitting a written grant proposal. If accepted, the financial grant is typically utilized to, inter alia, support research conducted in conjunction with the project and, in turn, draft an article derived from the research. Examples of well-known funding agencies include the National Institutes of Health (NIH), the Department of Energy (DOE), and the U.K.-based, Wellcome Trust.

The conventional grant submission process, which is currently utilized by most authors, has been found to suffer from a number of notable shortcomings. As a first shortcoming, the author is typically unable to readily identify which funding institutions would be most appropriate for the project, as there are numerous funding institutions located throughout the world and, at the same time, there is rather limited means for authors to research the funding history of each institution to determine a suitable match. In addition, an author typically submits grant proposals sequentially (i.e., with each successive request being sent only after receiving a rejection of the previous request), thereby creating a largely inefficient, time-consuming process. Lastly, as a result of the nature of the relationship between key participants in the authorship network, funding agencies only receive updates with respect to the article which it is funding (e.g., submitted for publication, accepted for publication, published, etc.) when such information is first communicated to the author from the publisher, this dynamic often serving as a key source of friction between publishers and authors.

With funding obtained and the article completed, the author must engage in a similarly complex and time-consuming publication submission process in order to complete the submission stage. Traditionally, authors submit an article to publishers either (i) through the manual submission of written publication requests in a sequential fashion or (ii) using an electronic-based submission system that is maintained by each publisher. Although known in the art, publisher-maintained systems have been found to be difficult to use and expensive to maintain, with each publisher system often being implemented with its own set of unique requirements and submission parameters, thereby further complicating the submission process for the author.

Upon completion of the submission stage, the article is then reviewed by industry peers in the pre-publication stage of the authorship workflow. As can be appreciated, peer-reviewed articles in the scientific, technical and medical markets are rapidly evolving, with researchers becoming more collaborative. As part of the pre-publication stage, assigned peer reviewers provide the publisher with any comments, suggestions and/or proposed edits in connection with the article. However, the current electronic tools available for use in the peer review process have been found to be rather deficient. As an additional shortcoming, the author is typically provided with limited access to the peer review commentary.

When the article is finalized and approved for publication, the authorship workflow proceeds to the publication stage. However, it should be noted that publication of the article by the publisher is often performed without any notification to interested participants of the authorship network (e.g., the author and funding agency), which is highly undesirable.

Once published, rights to the article are managed by the appropriate party in the post-publication phase. As a result, the post-publication phase includes, among other things, the handling of licensing fees from interested parties.

As can be appreciated, the collection of fees is not limited to post-publication. In fact, throughout the authorship workflow, the author is often charged a variety of fees by the publisher including, but not limited to, pre-publication phase fees (e.g., submission fees), publication phase fees (e.g., open access fees, page fees and color fees) and post-publication phase fees (e.g., reprints, offprints and eprints). Currently, publishers are provided with limited electronic-based means for processing the collection of these fees from authors, which, in turn, often results in untimely and/or mishandled payments.

In view of the above, the traditional authorship workflow has been found to be largely inadequate due to the inefficient, and often unsupported, nature in which information and payments are exchanged between participants. In particular, the lack of a standard tool for use by all of the participants results in a workflow that relies upon the execution of a substantial number of independent, uncorrelated steps, thereby rending the overall process not only time-consuming but also expensive to implement.

### SUMMARY OF THE INVENTION

It is an object of the present invention to provide a new and improved system and method for facilitating the advancement of a research article from conception to post-publication.

It is another object of the present invention to provide a system and method as described above that simplifies the manner in which the author of the research article researches grant institutions and, in turn, applies for funding therefrom.

It is yet another object of the present invention to provide a system and method as described above that simplifies the manner in which the author of a research article researches publishers and, in turn, submits publishing requests thereto.

It is still another object of the present invention to provide a system and method as described above that provides routine, real-time updates of the status of the research article to selected participants.

It is yet still another object of the present invention to provide a system and method as described above that facilitates the collection of annotations to the research article from peer reviewers.

It is another object of the present invention to provide a system and method as described above that facilitates the collection of fees between participants.

It is yet another object of the present invention to provide a system and method as described above that is efficient in operation and inexpensive to implement.

Accordingly, as one feature of the present invention, there is provided a method for facilitating the advancement of a research article from conception to post-publication using a workflow management system, the method comprising the steps of (a) conceiving a topic for the research article by an author in electronic communication with the workflow management system, and (b) submitting a grant request for the research article from the author to a plurality of funding agencies via workflow management system, each of the plurality of funding agencies being in electronic communication with the workflow management system, (c) wherein the workflow management system submits a grant request to the plurality of funding agencies in cascading fashion, with each successive grant request being submitted by the workflow management system only if the previous grant request is rejected.

As another feature of the present invention, there is provided a method for facilitating the advancement of a research article from conception to post-publication using a workflow management system, the method comprising the steps of (a) drafting a research article by an author in electronic communication with the workflow management system, and (b) submitting a publication request for the research article from the author to a plurality of publishers via workflow management system, each of the plurality of publishers being in electronic communication with the workflow management system, (c) wherein the workflow management system submits a publication request to the plurality of publishers in cascading fashion, with each successive publication request being submitted by the workflow management system only if the previous publication request is rejected.

As another feature of the present invention, there is provided a system for managing authorship workflow amongst an author and a plurality of partnering entities, each of the plurality of partnering entities being in electronic communication with the system, the system comprising (a) a processor for controlling the principal operations of the system, (b) a network interface adapted to connect to a communication network, and (c) a plurality of modules for carrying out specific tasks related to authorship workflow, wherein one of the plurality of modules is a submission services module that is adapted to transmit an author-initiated request to the plurality of partnering entities in cascading fashion, with each successive request being submitted by the submission services module only if the previous request is rejected.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a block diagram of a system for facilitating the advancement of research articles from conception to post-publication, the system being designed according to the teachings of the present invention;

FIG. 2 is a simplified block diagram of the central controller shown in FIG. 1;

FIG. 3 is a simplified block diagram of the data storage device shown in FIG. 1; and

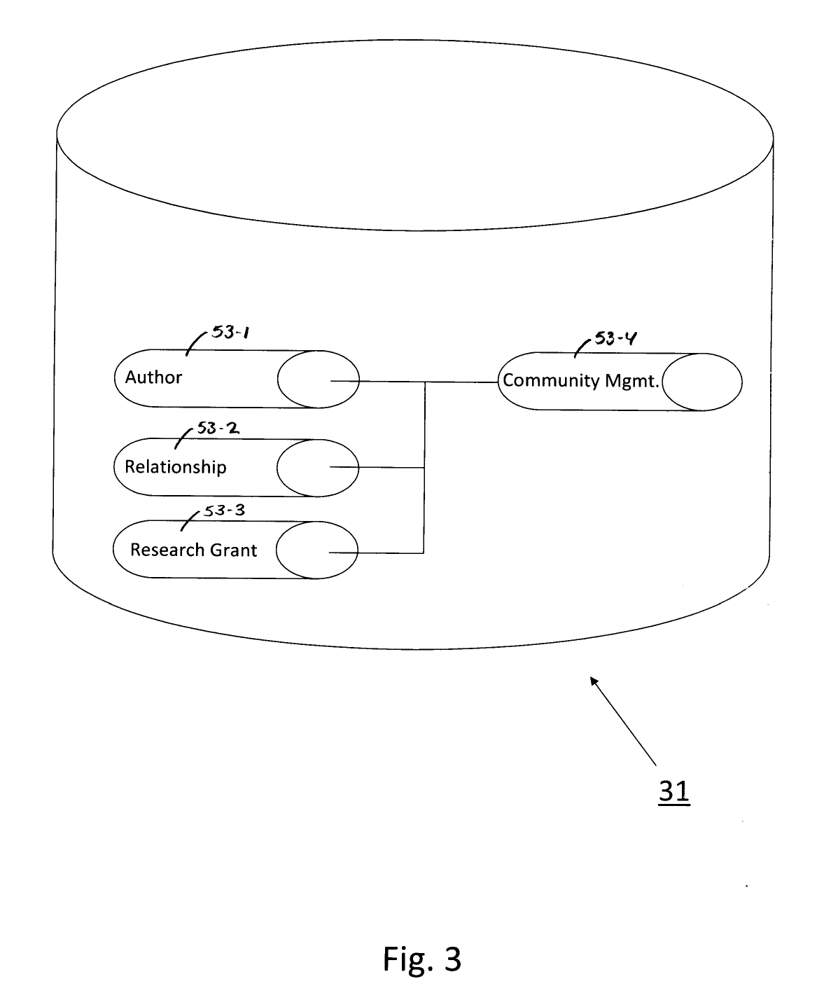

FIG. 4 is novel method for facilitating the advancement of research articles from conception to post-publication, the method being described herein according to the teachings of the present invention and implemented using the system shown in FIG. 1.

### DETAILED DESCRIPTION OF THE INVENTION

### Research Article Advancement Facilitation System 11

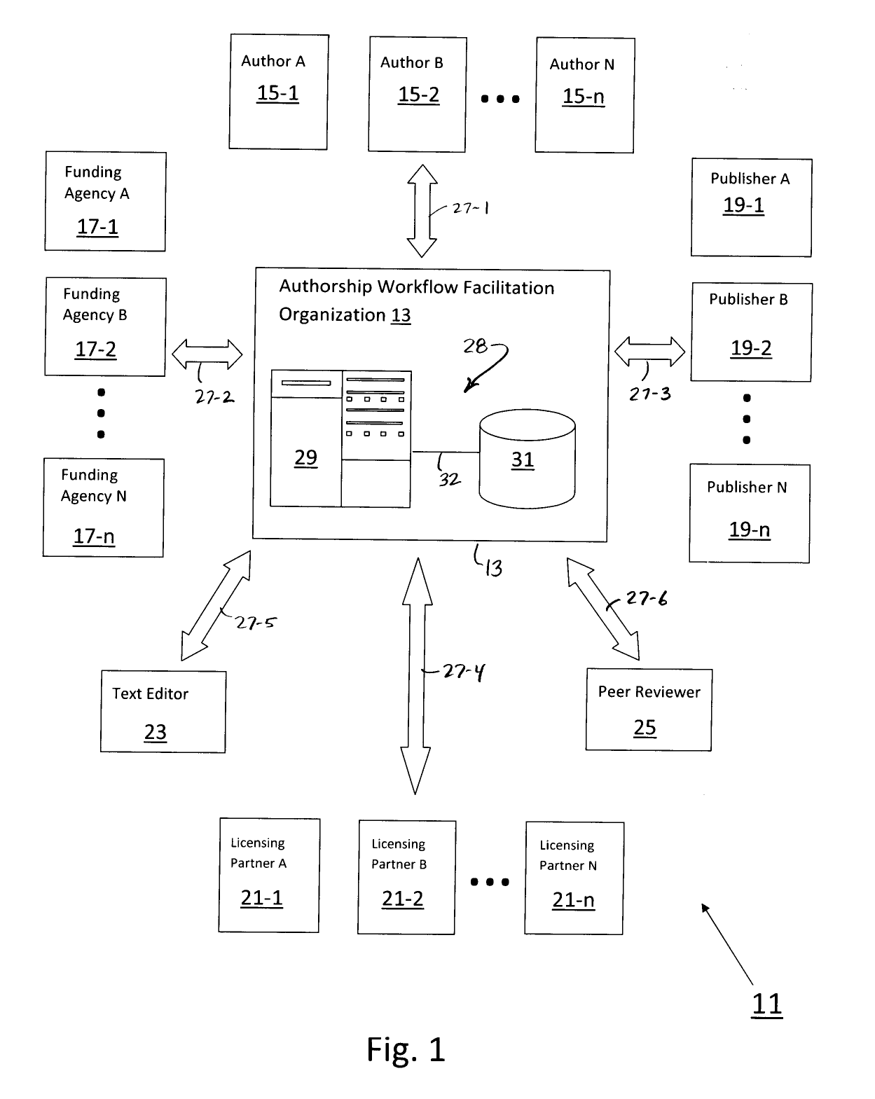

Referring now to FIG. 1, there is a shown a simplified block diagram of a system for facilitating the advancement of research articles from conception to post-publication, the system being designed according to the teachings of the present invention and being identified generally by reference numeral 11. As will be described further below, system 11 includes a web-based, aggregated solution that significantly simplifies authorship workflow.

As can be seen, system 11 comprises an authorship workflow facilitation organization 13 which serves as the central hub between the traditional participants involved in the creation, publication and licensing of research articles. Specifically, authorship workflow facilitation organization 13 is electronically linked with a plurality of research authors 15-1 thru 15-n, a plurality of funding agencies 17-1 thru 17-n, a plurality of publishers 19-1 thru 19-n, a plurality of licensing partners 21-1 thru 21-n, at least one text editor, or polisher, 23 and at least one peer reviewer, or supporter, 25. Accordingly, as a principal feature of the present invention, organization 13 streamlines the manner in which (i) an author 13 obtains a project grant from an interested funding agency 17, (ii) author 13 locates a publisher 19 willing to publish a research article derived from the funded project, and (iii) publisher 19 brokers copyright licenses for the published article with interested licensing partners 21, including the processing of any licensing fees associated therewith.

Organization 13 is represented herein as being electronically linked with authors 15, funding agencies 17, publishers 19, licensing partners 21, text polishers 23 and peer reviewers 25 via corresponding communication paths 27-1 thru 27-6, respectively. As defined herein, each communication path 27 represents any communication means suitable for the electronic transfer of data, such as the internet.

### Authorship Workflow Facilitation Organization 13

Authorship workflow facilitation organization 13 is provided with a workflow management system 28 that includes a central controller 29 and a data storage device 31 in electronic communication with one another via network path 32.

As can be appreciated, central controller 29 serves as the functional hub of system 11. Preferably, central controller 29 is represented herein as a web server that is responsible for regulating the exchange of data between the principal participants of system 11 through one or more designated web pages. However, it is to be understood that central controller 29 is not limited to a web server but rather could be in the form of alternative types of compute devices without departing from the spirit of the present invention.

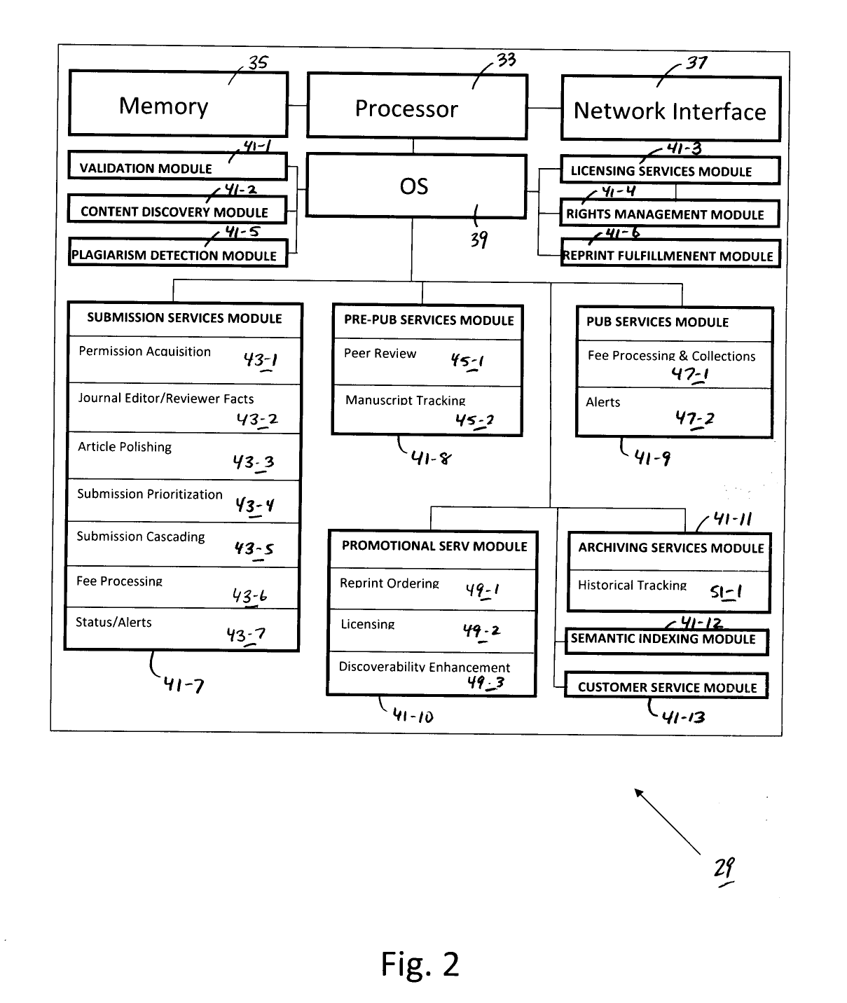

Referring now to FIG. 2, central controller 29 is conventional in its principal design in that controller 29 is preferably provided with, among other things, a processor 33 for controlling the principal operations of controller 29, a memory device 35 for storing data, a network interface 37 for enabling controller 29 to connect to a network, and an operating system 39 for controlling the performance of basic tasks.

Central controller 29 is unique in its design in that central controller 29 is provided with a plurality of modules 41 for carrying out various novel functions for workflow management system 28. Specifically, central controller 29 is provided with an author validation module 41-1, a content discovery services module 41-2, a licensing services module 41-3, a rights management module 41-4, a plagiarism detection module 41-5, a reprint fulfillment module 41-6, an author submission services module 41-7, a pre-publication services module 41-8, a publication services module 41-9, a promotional services module 41-10, an archiving services module 41-11, a semantic indexing module 41-12 and a customer service module 41-13, the function of each module 41 to be detailed further below.

Preferably, each module 41 includes a collection of routines that perform a system-level function that can be dynamically loaded and unloaded from central controller 29, as desired. Accordingly, it is to be understood central controller 29 is designed with an open architecture so as to allow for the addition, removal and/or replacement of the various individual modules 41 as deemed necessary. In this manner, central controller 29 is able to coordinate communications and transactions related to the article submission process, from pre-publication, author-oriented tasks to post-publication, publisher-related distribution and licensing tasks, within the current publishing framework but with the ability to adapt to future shifts.

It should be noted that certain modules 41 are designed to regulate the principal operations associated with a particular stage of the authorship workflow.

As an example, author submission services module 41-7 is designed to regulate the principal operations associated with the submission stage of the authorship workflow (i.e., from project conception to article submission for publication). Accordingly, author submission services module 41-7 preferably comprises a permission acquisition feature 43-1, an article reviewer feature 43-2, an article polishing feature 43-3, a submission prioritization feature 43-4, a submission cascading feature 43-5, a fee processing feature 43-6 and a status alert feature 43-7, the function of each feature 43 to be explained further in detail below.

As another example, pre-publication services module 41-8 is designed to regulate the principal operations associated with the pre-publication stage of the authorship workflow (e.g., the review, proofing and finalization of the article before publication). Accordingly, pre-publication services module 41-8 includes a peer review feature 45-1 and a manuscript tracking feature 45-2, the function of each feature 45 to be explained further in detail below.

As yet another example, publication services module 41-9 is designed to regulate the principal operations associated with the publication stage of the authorship workflow (e.g., the collection of author fees). Accordingly, publication services module 41-9 includes a fee processing and collection feature 47-1 and a publication alert feature 47-2, the function of each feature 47 to be explained further in detail below.

As yet still another example, promotional services module 41-10 and archiving services module 41-11 are together designed to regulate the principal operations associated with the post-publication stage of the authorship workflow (e.g., licensing of the article). As will be detailed further below, promotional services module 41-10 includes a reprint ordering feature 49-1, a licensing feature 49-2, and a discoverability enhancement feature 49-3, whereas archiving services module 41-11 includes a historical tracking feature 51-1.

Data storage device 31 is responsible for storing selected information relating to authorship workflow, the particular information stored on device 31 to be discussed further in detail below. For ease of illustration, data storage device 31 is represented herein as being located in the same facility as controller 29 and electrically connected thereto through direct communication path 32 (e.g., by a local area network). However, it should be noted that data storage device 31 could be remotely located and electrically connected to controller 29 by alternative means (e.g., via the cloud) without departing from the spirit of the present invention.

Data storage device 31 represents a standard storage device that is provided with a plurality of selectively interrelated databases 53 that are controlled by a database management system. Preferably, a content security system (not shown) monitors data storage device 31 and provides the necessary data protection.

As noted briefly above, data storage device 31 includes a plurality of databases 53. In the present embodiment, data storage device 31 is shown comprising an author database 53-1, a relationship database 53-2, a research grant database 53-3 and a community management database 53-4, the function of each database 53 to be described further below.

It should be noted that the particular databases 53 provided in data storage device 31 above are merely exemplary. In fact, it is to be understood that data storage device 31 could include a fewer or greater number of designated databases to provide workflow management system 28 with alternative capabilities without departing from the spirit of the present invention.

Author database 53-1 is designed to establish and track a profile for each registered author 15. The data collected in connection with each author 15 may include, inter alia, all new and/or previously published works, funding history, usage statistics, purchase history as well as other relevant data.

Relationship database 53-2 is designed to track interactions between participants of system 11 via workflow management system 28. For example, relationship database 53-2 tracks interactions between registered authors 15 who collaborate on a given research paper. As another example, relationship database 53-2 maintains links between a registered author 15 and a particular institution (e.g., when author 15 is employed by the institution, such as faculty at a university).

Research grant database 53-3 is designed to compile data relating to grants and, as such, is populated with information including (i) the subject area of each grant, (ii) a list of affiliated funding agencies 17 and related decision-making bodies, such as editorial boards and government agencies, and (iii) historical data on past grants submitted through organization 13, along with textual commentary from grant applicants and recipients.

Community management database 53-4, in connection with an application server (e.g., controller 29), is designed to promote community commentary and interaction, such as through utilization of designated chat rooms and discussion boards. As a result of its intent, it is to be understood that community management database 53-4 is preferably closely integrated with author database 53-1 as well as relationship database 53-2.

### Research Article Advancement Facilitation Method 111

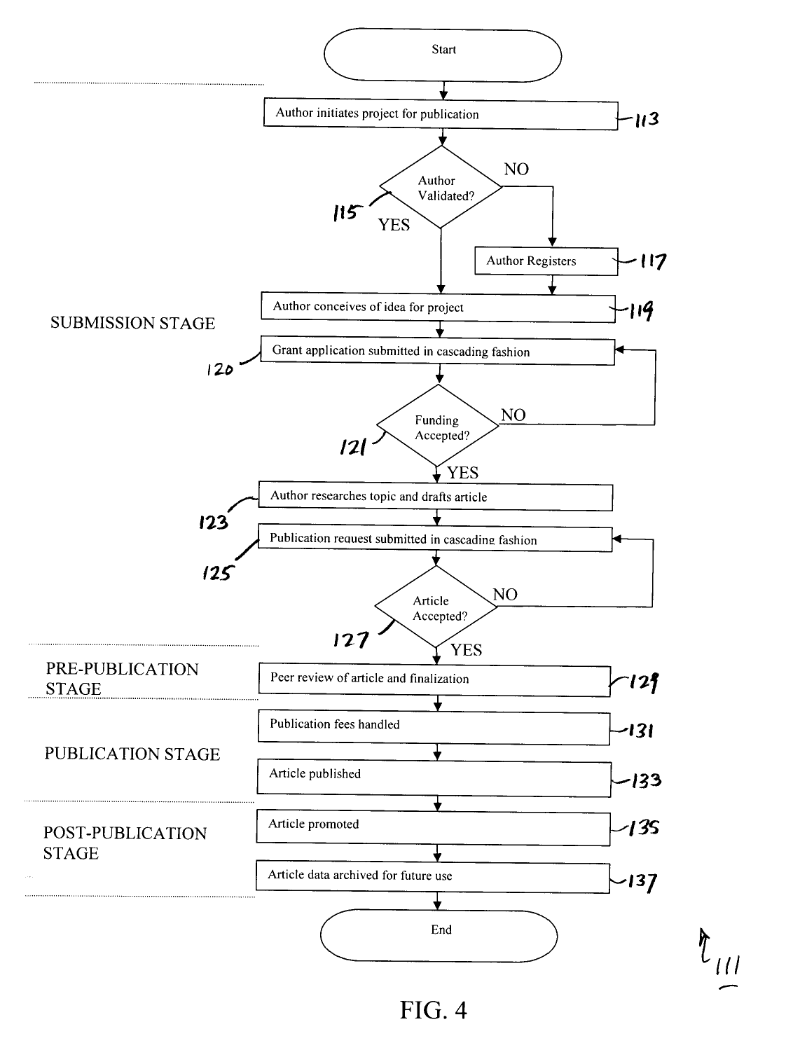

Referring now to FIG. 4, workflow management system 28 is specifically designed to implement a novel method for facilitating the advancement of research articles from conception to post-publication, the method being set forth in detail below and identified generally by reference numeral 111. As will be described further below, method 111 allows for the exchange of information between participants of system 11 in an efficient and reliable manner, which is a principal object of the present invention.

As can be seen, method 111 commences upon the decision by an author 15 (e.g., author A) to initiate a project for publication, the project initiation step being identified by reference numeral 113. As part of project initiation step 113, author 15 must validate proper registration information with organization 13 through an appropriate web portal operated by central controller 29 (e.g., via an OpenID/Link validation system that requires the input of an appropriate username and password). In a subsequent step 115, central controller 29 determines whether author 15 has previously established an authorship account with organization 13 by cross-referencing the entered login information against registration information tables stored within author database 53-1 in data storage device 31.

As can be appreciated, validation module 41-1 is provided with tools for creating and maintaining Open Researcher and Contributer IDs, or ORCIDs, which are unique identifiers for authors and creators. Accordingly, if author 15 has not previously registered with organization 13, an appropriate web page is initiated that requests author 15 to provide user-specific registration information, the registration step being identified by reference numeral 117. In response thereto, an appropriate author account is established in author database 53-1 which can be used to establish and track a profile for author 15 relating to, inter alia, new and previously published works, funding history, usage statistics, purchase history as well as other relevant data. Once registration step 117 is completed, method 111 advances to an idea conception step 119.

By contrast, if author 15 has previously registered with organization 13 (which is validated by cross-referencing the provided login information against stored account information), method 111 skips registration information input step 117 and proceeds directly to idea conception step 119.

In idea conception step 119, author 15 engages in the conception and formulation of an idea for a research project which will later form the basis of a research grant proposal. To assist author 15 in step 119, content discovery services module 41-2 provides author 15 with access to, among other things, services for conducting preliminary research in connection with the project, including locating other pertinent publications in the field (as well as the editors and grant institutions associated said publications). Content discovery services module 41-2 additionally includes tools for renting and viewing content through a content viewer, note taking, bookmarking, receiving recommendations for additional resources, and recording bibliographic information.

It should be noted that the content viewer provided to author 15 through content discovery services module 41-2 preferably allows for the recognition of references embedded in the content. The content viewer may also link to or embed other search tools that are known in the art, such as the Pubget® search engine for research papers. For example, the pathing and holdings information in a content viewing service can be used to link the searcher to both subscribed and unsubscribed content. Content discovery services module 41-2 further preferably provides social media tools for collaboration with peers.

The content provided through content discovery services module 41-2 interacts with licensing services module 41-3 to obtain the necessary licenses for use of copyrighted content. Licensing services module 41-3 is, in turn, controlled by the rules defined in rights management module 41-4, the rules being established using content information provided by publisher 19 as well as author information retrieved from author database 53-1, with search terms and notes stored in author database 53-1 for future access, if needed.

Upon completion of conception step 119, author 15 then seeks to obtain a financial grant from a partner funding agency 17 in order to, inter alia, support further research in conjunction with the project as well as draft a journal article derived from the research, the grant application step being identified generally by reference numeral 120. As will be described below, workflow management system 28 is designated to support the grant process throughout its several stages.

As part of grant application step 120, author 15 continues to research sources for relevant information, such as notable publications as well as the editors and funding organizations associated with such publications. If permission to a particular resource is required, permission acquisition feature 43-1 of author submission services module 41-7 generates a permission request from author 15 and, in turn, facilitates acquisition of rights to reuse third-party STM journal articles from the appropriate publisher 19.

Author 15 can also obtain relevant grant-related information from certain publishers 19 through journal editor facts feature 43-2 of author submission services module 41-7. For instance, author 15 can discover, among other things, (i) past grant recipients, (ii) the particular subject, or topic, associated with successful grants as well as (iii) profiles of editors and grant reviewers.

If desired, author 15 can additionally utilize relationship database 53-2 to search for and communicate with collaborators, to post questions to the community, and review prior feedback. Once a grant proposal has been drafted, author 15 can (i) share longer selections of narrative text from the grant proposal with selected peer reviewers 25 for feedback, and/or (ii) seek assistance in editing the grant proposal from a designated text editor 23 or colleague using article polishing feature 43-3 of author submission services module 41-7.

It should be noted that article polishing feature 43-3 of author submission services module 41-7 supports language polishing and translational services through designated partnerships. In addition, article polishing feature 43-3 cooperates with plagiarism detection module 41-5 to analyze the grant proposal in view of research collected using content discovery services module 41-2 in an effort to prevent plagiarism.

Grant application step 120 then utilizes an automated, cascading grant submission process to improve overall efficiency. Specifically, through submission prioritization feature 43-4 of author submission services module 41-7, author 15 prioritizes, or ranks, the funding agencies 17 from which a grant is desired. Once a grant institution hierarchy is established, submission cascading feature 43-5 automatically submits the completed grant proposal on behalf of author 15 to the highest ranked funding agency 17 in the hierarchy.

In step 121, the grant proposal is reviewed by the funding agency 17 that received the submission, with the acceptance or rejection of the proposal from funding agency 17 being received directly by submission cascading feature 43-5. If the grant proposal is rejected by the reviewing agency 17, method 111 returns to step 120 and submission cascading feature 43-5 initiates the submission of the grant proposal on behalf of author 15 to the next ranked funding agency 17 in the previously established hierarchy, with the process repeating until the grant proposal is accepted by a funding agency 17. Once the grant proposal is accepted, method 111 proceeds to a research and article drafting step 123.

As can be appreciated, the cascading fashion in which workflow management system 28 automatically submits the completed grant proposal to a preferred, prioritized list of funding agencies 17 significantly streamlines the traditional manner in which an author 15 seeks funding from grant institutions (e.g., by manually submitting grant proposals, one-by-one, and awaiting response before sending subsequent requests). Accordingly, it is to be understood that the aforementioned grant proposal submission process serves as a principal novel feature of the present invention.

In step 123, author 15, who is now funded by a partner funding agency 17, engages in the principal research for the project as well as the drafting of an article derived from the research. During step 123, author 15 can further utilize author submission services module 41-7 for a variety of purposes including, but not limited to, permission acquisition of copyrighted publications and locating published articles in the field to review pertinent information associated therewith, such as editorial staffs utilized as well as statistics relating to impact within the community (e.g., the number of times an article is read, cited, licensed, etc.).

It should be noted that some of the features provided by author submission services module 41-7 may be available for use by author 15 at no charge, whereas other features provided by author submission services module 41-7 may only be available to paid subscribers. In this scenario, it is envisioned that author submission services module 41-7 would be readily able to differentiate the availability of features amongst users (e.g., by examining the payment category of author 15 in author database 53-1).

As part of step 123, it is to be understood that author 15 can optionally utilize text polishers 23 to edit, translate and/or reformat (to enhance discoverability on websites) the drafted article via article polishing feature 43-3 of author submission services module 41-7.

Once satisfied with the condition of the article, author 15 then engages in an article submission process with selected STM publishers 19, the article submission step being identified generally by reference numeral 125. In a similar fashion to grant application step 119, article submission step 125 utilizes an automated, cascading submission process to improve overall efficiency. Specifically, through prioritization feature 43-4 of author submission services module 41-7, author 15 prioritizes, or ranks, the STM publishers 19 by which publication of the article is desired. Once a final publisher hierarchy is confirmed by author 15, submission cascading feature 43-5 automatically submits the finished research article on behalf of author 15 to the highest ranked publisher 19 in the hierarchy.

In step 127, the research article is reviewed by the publisher 19 that received the publication submission. If the research article submission is rejected by the publisher 19, method 111 returns to step 125 and cascading feature 43-5 of author submission services module 41-7 initiates the submission of the finished article on behalf of author 15 to the next ranked publisher 19 in the previously established hierarchy, with the process repeating until the article publication submission is accepted by a publisher 19.

As can be appreciated, the cascading fashion in which workflow management system 28 automatically submits the research article to a preferred, prioritized list of publishers 19 significantly streamlines the traditional manner in which an author 15 reaches an agreement of article publication with publishing companies (e.g., through the use of an electronic-based submission system maintained by each publisher 19). Accordingly, it is to be understood that the aforementioned article publication submission process serves as a principal novel feature of the present invention.

It should be noted that, as part of submission stage of the authorship workflow, fee processing feature 43-6 of author submission services module 41-7 manages the electronic payment of article submission fees from author 15 to publishers 19. Furthermore, status alert feature 43-7 of author submission services modules 41-7 is designed to automatically send a wide variety of user-defined status alerts (e.g., by email or RSS stream) to selected individuals (e.g., to the partner funding agency 17 when the article has been submitted for publication, to the partner funding agency 17 and author 15 when the article has been accepted for publication 19, etc.).

Once the application has accepted for publication, method 111 proceeds to an article review/finalization step 129 in the pre-publication stage of the authorship workflow in which the article is reviewed by a peer reviewer, or committee, 25. Support for peer review is provided through peer review and editor assistance feature 45-1 of pre-publication services module 41-8.

Peer review and editor assistance feature 45-1 of pre-publication services module 41-8 is preferably designed to provide each peer reviewer 25 that is assigned to the article with access to the functionality of content discovery module 41-1 in order to (i) navigate to related articles, (ii) associate new references with the article, and (iii) attach textual or pictorial comments with the associated references. Furthermore, plagiarism detection module 41-5 can be utilized by reviewers 25, as well as editors 23, to detect plagiarism and to research both related topics and works cited in the article to ensure compliance with publisher standards.

Pre-publication services module 41-8 is additionally provided with a manuscript tracking feature 45-2 that collects the text modifications proposed by peer reviewers 25 and, in turn, enables the modifications to be either accepted or rejected by publisher 19. Manuscript tracking feature 45-2 additionally serves to (i) manage the transfer of copyright ownership from author 15 to publisher 19, (ii) update author 15 on the status of the article (including the acceptance/rejection of modification proposals as well as reviewer annotations), (iii) compile data on each peer reviewer 25 assigned to the article (e.g., experience, previous articles reviewed), and (iv) manage information relating to licensing options and limitations.

Upon completion of step 129, the research article is finalized and approved for publication, thereby advancing the process into the publication stage of the authorship workflow. Accordingly, in step 131, any publication fees that require payment by author 15 to publisher 19 (e.g., open access fees, page fees and/or color fees) are handled by fee processing and collection feature 47-1 of publication services module 41-9. In particular, feature 47-1 is responsible for, inter alia, assisting in the negotiation of fees between author 15 and publisher 19, collecting electronic payment from author 15 and, in turn, distributing the payment to publisher 19, and notifying funding agency 17 of any payment required to publisher 19. In addition, workflow management system 28 (i) continues to manage all rights to the article (whether held by author 15 or publisher 19 or any other party) and (ii) tracks metadata associated with the article.

Upon receipt of the appropriate publication fee in step 131, publisher 19 proceeds with publication of the article in step 133, thereby completing the publication stage of the authorship workflow. As part of publication step 131, an electronic notification is sent by workflow management system 28 to the appropriate funding agency 17 and author 15 via alerts feature 47-2 of publication module 41-9.

As part of the post-publication phase of the authorship workflow, method 111 proceeds from publication step 133 to an article promotion step 135 in which billings, collections, reports and customer service are aggregated for publisher 19. Specifically, in step 135, workflow management system 28 assists in promoting the published article by, inter alia, (i) managing the reprints, rentals and fulfillments via ordering feature 49-1 of promotional services module 41-10 (in conjunction with reprints fulfillment module 41-6 and publisher 19), (ii) handling licensing opportunities via licensing feature 49-2 of promotional services module 41-10 (in conjunction with rights management module 41-4), and (iii) enhancing discoverability of the article on websites, such as publisher websites, via discoverability enhancement feature 49-3 of promotional services module 41-10 (in conjunction with semantic indexing module 41-12).

As an additional component of the post-publication phase of the authorship workflow, method 111 concludes with a data archiving step 137. In step 137, a historical tracking feature 51-1 in archiving services module 41-11 provides access to historical data stored in data storage device 31, such as article revisions and personalized notes designated for potential use by author 15 if future revision of the article is required. A version history and impact factor tracking feature in archiving services module 41-11 works with article publisher 19, author database 53-1, and the recommendation feature of content discovery module 41-2 to provide an article version history and impact tracking.

It should be noted that customer support module 41-13 is a centralized module that works in conjunction with publisher 19 and author 15 (via author database 53-1) to provide the necessary customer support services throughout authorship workflow, as needed.

### Select Features and Advantages of the Present Invention

Method 111, as set forth in detail above, yields a number of notable advantages over traditional authorship workflows.

As a first advantage, method 111 is a comprehensive, all-in-one, web-based, workflow solution that streamlines numerous stages in the authorship experience, from the conception of an idea, to the application for a financial grant, to the creation of a manuscript, and ultimately extending throughout the entire post-publication process, while increasing efficiency and reducing publisher costs.

As a second advantage, method 111 improves the manner in which an author 15 conducts research by including tools for, inter alia, (i) facilitating the search of content by saving search strategy notes and recommendations, (ii) obtaining licenses to third party works that are to be ultimately incorporated by author 15 in the research article, and (iii) providing background information on publishers 19 and editors 23 involved with similar projects as well as peer reviewers 25 who are likely to review the article.

As a third advantage, method 111 facilitates the grant acquisition process by providing author 15 with (i) access to a database of useful grant information, including pertinent information on funding agencies 17 and historical data relating to past grants submitted through organization 13, and (ii) the ability to submit a grant proposal in a cascading fashion to a prioritized list of funding agencies 17.

As a fourth advantage, method 111 facilitates the publication submission process by providing author 15 with the ability to (i) research pertinent information on publishers 19 and, in turn, (ii) submit a publication request in a cascading fashion to a prioritized list of publishers 19.

As a fifth advantage, method 111 enables author 15 to share selections of the research article with select individuals and, in turn, request feedback, text polishing and/or translational services.

As a sixth advantage, method 111 is designed to electronically handle all fee transactions in a simplified manner, including the payment of fees from author 15 and/or funding agency 17 to publisher 19.

As a seventh advantage, method 111 is designed to provide a variety of automated alerts (e.g., status alerts, fee payments, etc.) to both author 15 and funding agency 17 throughout selected stages of authorship workflow.

As an eighth advantage, method 111 provides a peer reviewer 25 with (i) electronic access to the research article, (ii) tools to search for relevant content, check for possible plagiarism, associate new references with the work, and attach textual or pictorial comments with the associated references, and (iii) the directly incorporate edits into the article that, in turn, can be either accepted or rejected by publisher 19.

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A method for facilitating the advancement of a research article from conception to post-publication using a workflow management system, the method comprising the steps of:
(a) conceiving a topic for the research article by an author in electronic communication with the workflow management system; and
(b) submitting a grant request for the research article from the author to a plurality of funding agencies via workflow management system, each of the plurality of funding agencies being in electronic communication with the workflow management system;
(c) wherein the workflow management system submits a grant request to the plurality of funding agencies in cascading fashion, with each successive grant request being submitted by the workflow management system only if the previous grant request is rejected.

2. The method of claim 1 further comprising the step of, prior to the grant request submission step, establishing a prioritization list of the plurality of funding agencies in the workflow management system by the user.

3. The method of claim 2 wherein each grant request is electronically transmitted from the workflow management system to the plurality of funding agencies in cascading fashion in compliance with the prioritization list.

4. The method of claim 3 further comprising the step of, prior to the prioritization step, compiling historical, grant-related information on the plurality of funding agencies by the author via workflow management system.

5. The method of claim 1 further comprising the steps of:
(a) allocating a research grant from a funding agency to the author in accordance with the grant request;
(b) engaging in research in connection with the topic by the author through support of the research grant; and
(c) drafting of the research article by the author using the research derived from the engaging step, the drafted research article being captured by the workflow management system.

6. The method of claim 5 further comprising the step of, after the drafting step, submitting a publication request for the research article from the author to a plurality of publishers via workflow management system, each of the plurality of publishers being in electronic communication with the workflow management system, wherein the workflow management system submits a publication request to the plurality of publishers in cascading fashion, with each successive publication request being submitted by the workflow management system only if the previous publication request is rejected.

7. The method of claim 6 further comprising the step of, prior to the publication request submission step, establishing a prioritization list of the plurality of publishers in the workflow management system by the user.

8. The method of claim 7 wherein each publication request is electronically transmitted from the workflow management system to the plurality of funding agencies in cascading fashion in compliance with the prioritization list of the plurality of publishers.

9. The method of claim 6 further comprising the step of transmitting author-defined, research article-related status alerts from the workflow management system to the author and the funding agency that allocated the research grant to the author.

10. The method of claim 9 wherein the status alert is transmitted by the workflow management system when a publication request is either submitted to a publisher, accepted by a publisher or rejected by a publisher.

11. The method of claim 6 further comprising the step of handling the electronic payment of fees from the author to the publisher via workflow management system.

12. The method of claim 6 further comprising the step of, prior to the grant request submitting step, conducting preliminary research in connection with the topic by the author via workflow management system.

13. The method of claim 13 wherein the conducting preliminary research step comprises the steps of:
(a) locating content to be incorporated in the research article by the author via workflow management system; and
(b) acquiring permission for use of the content in the research article from an owner of the content in electronic communication with the workflow management system.

14. The method of claim 13 wherein the acquisition of permission for use of the content is controlled by rights management rules stored in the workflow management system.

15. The method of claim 12 wherein, as part of the conducting preliminary research step, the workflow management system stores search history as well as search strategy notes and recommendations that are input into workflow management system by the author.

16. The method of claim 12 further comprising the step of comparing the research article against searched content located by the user via workflow management system to detect plagiarism.

17. The method of claim 6 further comprising the steps of:
(a) accepting the publication request by a publisher via workflow management system,
(b) examining the research article by a peer reviewer in electronic communication with the workflow management system, the peer reviewer being able to search for content, associate references with the article, and retrieve search strategy notes and recommendations previously input by the author via workflow management system.

18. The method of claim 6 further comprising the step of, prior to the publication request submission step, requesting by the author via workflow management system of feedback of at least a portion of the research article from an editor in electrical communication with the workflow management system.

19. A method for facilitating the advancement of a research article from conception to post-publication using a workflow management system, the method comprising the steps of:
(a) drafting a research article by an author in electronic communication with the workflow management system; and
(b) submitting a publication request for the research article from the author to a plurality of publishers via workflow management system, each of the plurality of publishers being in electronic communication with the workflow management system;
(c) wherein the workflow management system submits a publication request to the plurality of publishers in cascading fashion, with each successive publication request being submitted by the workflow management system only if the previous publication request is rejected.

20. A system for managing authorship workflow amongst an author and a plurality of partnering entities, each of the plurality of partnering entities being in electronic communication with the system, the system comprising:
(a) a processor for controlling the principal operations of the system;
(b) a network interface adapted to connect to a communication network; and
(c) a plurality of modules for carrying out specific tasks related to authorship workflow, wherein one of the plurality of modules is a submission services module that is adapted to transmit an author-initiated request to the plurality of partnering entities in cascading fashion, with each successive request being submitted by the submission services module only if the previous request is rejected.
